(19) United States
(12) Patent Application Publication
(10) Pub. No.: US 2014/0241459 A1
(43) Pub. Date: Aug. 28, 2014

(54) CLOCK-EMBEDDED DATA GENERATING APPARATUS AND TRANSMISSION METHOD THEREOF

(71) Applicant: Novatek Microelectronics Corp., Hsinchu (TW)

(72) Inventors: Po-Hsiang Fang, Hsinchu City (TW); Shun-Hsun Yang, Hsinchu City (TW); Han-Ying Chang, Hsinchu City (TW)

(73) Assignee: Novatek Microelectronics Corp., Hsinchu (TW)

(21) Appl. No.: 13/972,927

(22) Filed: Aug. 22, 2013

(30) Foreign Application Priority Data
Feb. 26, 2013 (TW) 102106764

(51) Int. Cl. H04L 1/00

(52) U.S. Cl. CPC H04L 1/0023
USPC 375/296

(57) ABSTRACT

A clock-embedded data generating apparatus and transmission method are disclosed. The steps of the transmission method include: generating a plurality of preamble signals according to a number sequence, where each of the preamble signals has a plurality of bits. The number sequence includes a plurality of values, and the bits of each of the preamble signals are decided by each of the corresponding values; transmitting the preamble signals during a plurality of preamble signal transmitting periods respectively, and transmitting a plurality of data signal during a plurality of data signal transmitting periods respectively.

### CROSS-REFERENCE TO RELATED APPLICATION

This application claims the priority benefit of Taiwan application serial no. 102106764, filed on Feb. 26, 2013. The entirety of the above-mentioned patent application is hereby incorporated by reference herein and made a part of this specification.

### BACKGROUND

1. Technical Field

The invention relates to a clock-embedded data generating apparatus and a signal transmission method thereof Particularly, the invention relates to a clock-embedded data generating apparatus capable of reducing radio frequency noise and a signal transmission method thereof

2. Related Art

In a signal transmission system of clock-embedded data, one of the transmission methods is to add one or a plurality of preamble signals having a fixed form transition to data, and a clock-embedded data recovery (CDR) system at a receiver end can recover data in a clock-embedded data signal according to the preamble singles.

Referring to FIG. 1, FIG. 1 is a waveform diagram of a conventional clock-embedded data signal 100. The clock-embedded data signal 100 includes a preamble signal 101, a data signal 102, a preamble signal 103 and a data signal 104 arranged in a sequence. The preamble signal 101 and the preamble signal 103 are all composed of two bits 0 and 1 in sequence, so that both of the preamble signal 101 and the preamble signal 103 have a signal transition action transited from a logic low level to a logic high level. The fixed signal transition action is not disappeared as data of the data signal 102 and the data signal 104 changes. Namely, in the transmission method of the conventional clock-embedded data signal 100, due to the fixed transition phenomenon of the periodical preamble signals, electromagnetic interference (EMI) is generated.

### SUMMARY

The invention is directed to a method for transmitting clock-embedded data, by which radio frequency (RF) noise generated due to transition of the clock-embedded data is effectively decreased.

The invention is directed to a clock-embedded data generating apparatus, which effectively decreases RF noise generated due to transition of the clock-embedded data.

The invention provides a method for transmitting clock-embedded data, which includes following steps. A plurality of preamble signals is generated according to a number sequence, where each of the preamble signals includes a plurality of bits. The number sequence includes a plurality of values, and the bits of each of the preamble signals are decided by each of the corresponding values. The preamble signals are respectively transmitted during a plurality of preamble signal transmitting periods, and a plurality of data signals are respectively transmitted during a plurality of data signal transmitting periods. Each of the data signal transmitting periods occurs after each of the preamble signal transmitting periods.

In an embodiment of the invention, the method for transmitting the clock-embedded data further includes generating the number sequence according to a random number generation method.

In an embodiment of the invention, the method for transmitting the clock-embedded data further includes generating a plurality of random number generation results according to a random number generation method, and performing a logic operation on the random number generation results to generate the number sequence.

In an embodiment of the invention, the method for transmitting the clock-embedded data further includes generating the number sequence through a scrambler.

In an embodiment of the invention, the bits of each of the preamble signals are not completely the same.

The invention provides a clock-embedded data generating apparatus including a number sequence generator and a controller. The number sequence generator generates a number sequence. The controller is coupled to the number sequence generator, and sequentially generates a plurality of preamble signals according to the number sequence. Each of the preamble signals includes a plurality of bits. The number sequence includes a plurality of values, and the bits of each of the preamble signals are decided by each of the corresponding values. Moreover, the controller respectively transmits the preamble signals during a plurality of preamble signal transmitting periods, and respectively transmits a plurality of data signals during a plurality of data signal transmitting periods. Each of the data signal transmitting periods occurs after each of the preamble signal transmitting periods.

According to the above descriptions, a plurality of preamble signals are generated according to the number sequence, and at least one of a plurality of bits of the preamble signal in the clock-embedded data is dynamically changed to change a state of signal transition occurred between the bits of the preamble signal. In this way, RF noise generated by the preamble signals during transmission of the clock-embedded data is effectively decreased, so as to improve transmission accuracy of the clock-embedded data.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a waveform diagram of a conventional clock-embedded data signal 100.

FIG. 2 is a flowchart illustrating a method for transmitting clock-embedded data according to an embodiment of the invention.

FIG. 3A is waveform diagram of a clock-embedded data signal 300 according to an embodiment of the invention.

FIG. 3B is waveform diagram of a clock-embedded data signal 301 according to another embodiment of the invention.

FIG. 3C is a waveform diagram of a clock-embedded data signal 302 according to another embodiment of the invention.

FIG. 4A is a schematic diagram of a clock-embedded data generating apparatus 400 according to an embodiment of the invention.

FIG. 4B is a schematic diagram of a clock-embedded data generating apparatus 400 according to another embodiment of the invention.

FIG. 5 is a schematic diagram of a linear shift feedback register (LSFR) 500 according to an embodiment of the invention.

FIG. 6 is another implantation of a number sequence generator 600 of clocked-embedded data according to an embodiment of the invention.

### DETAILED DESCRIPTION OF DISCLOSED EMBODIMENTS

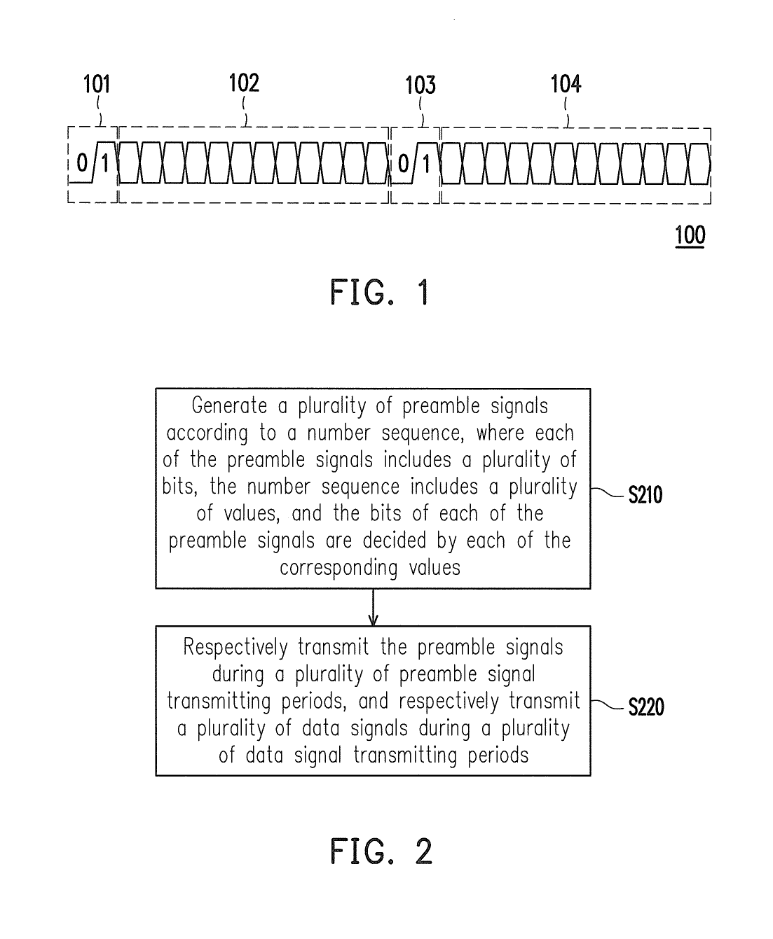

Referring to FIG. 2, FIG. 2 is a flowchart illustrating a method for transmitting clock-embedded data according to an embodiment of the invention. In the present embodiment, the method for transmitting clock-embedded data includes following steps. In step S210, a plurality of preamble signals is generated according to a number sequence, where each of the preamble signals includes a plurality of bits. The number sequence includes a plurality of values, and the bits of each of the preamble signals are decided by each of the corresponding values. In brief, the preamble signal, for example, has two bits, and the number sequence includes one or a plurality of “0” and one or a plurality of “1”. The two bits of the preamble signal can be set as “0” and “1” arranged in sequence when the value of the corresponding number sequence is equal to 0, comparatively, the two bits of the preamble signal can be set as “1” and “0” arranged in sequence when the value of the corresponding number sequence is equal to 1.

Then, in step S220, the preamble signals set in the step S210 are respectively transmitted during a plurality of preamble signal transmitting periods, and a plurality of data signals are respectively transmitted during a plurality of data signal transmitting periods, where each of the data signal transmitting periods occurs after the corresponding preamble signal transmitting period. Namely, each of the data signal transmitting periods is accompanied with a corresponding preamble signal transmitting period in front.

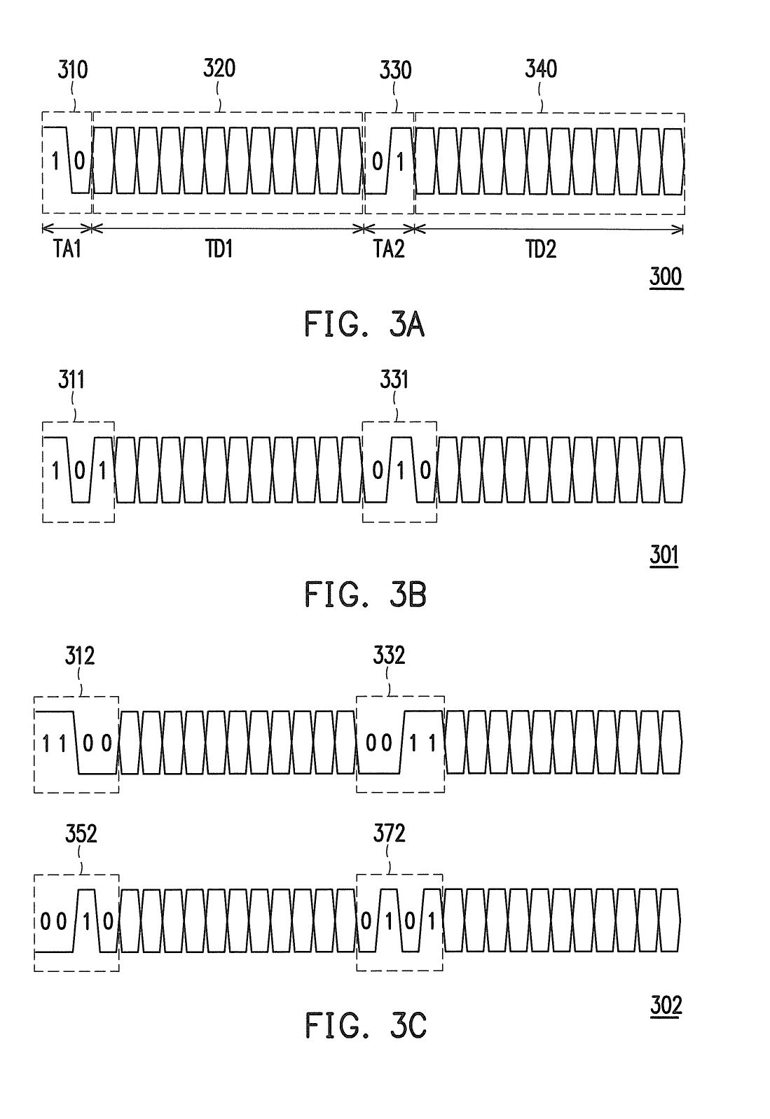

Referring to FIG. 2 and FIG. 3A, FIG. 3A is a waveform diagram of a clock-embedded data signal 300 according to an embodiment of the invention. Continuing with the previous example that the preamble signal has two bits, in case that the values of the number sequence are sequentially “1” and “0”, the number of the number sequence corresponding to the preamble signal 310 in the clock-embedded data signal 300 is “1”, therefore, the bits of the preamble signal 310 are sequentially set as “1” and “0”. Moreover, the number of the number sequence corresponding to the preamble signal 330 in the clock-embedded data signal 300 is “0”, therefore, the bits of the preamble signal 330 are sequentially set as “0” and “1”.

In the clock-embedded data signal 300 of FIG. 3A, a voltage level of the preamble signal 310 transmitted during a preamble signal transmitting period TA1 is transited from a logic high level to a logic low level, and a voltage level of the preamble signal 330 transmitted during a preamble signal transmitting period TA2 is transited from the logic low level to the logic high level. Namely, in the clock-embedded data signal 300, a transition manner of the preamble signals is not fixed, which may effectively decrease energy of the generated electromagnetic interference (EMI).

It should be noticed that in the present embodiment, a data signal transmitting period TD1 occurs after the preamble signal transmitting period TA1, which is used for transmitting a data signal 320, and a data signal transmitting period TD2 occurs after the preamble signal transmitting period TA2, which is used for transmitting a data signal 340.

Referring to FIG. 3B, FIG. 3B is waveform diagram of a clock-embedded data signal 301 according to another embodiment of the invention. Different to the aforementioned embodiment, the preamble signal of the clock-embedded data signal 301 includes three bits. Namely, the number sequence used for generating the preamble signals includes six different values to, which are respectively used to set the three bits of each of the preamble signals to be sequentially equal to “0” “0” “1”, “0” “1” “1”, “0” “1” “0”, “1” “0” “0”, “1” “0” “1” or “1” “1” “0”.

In FIG. 3B, the three bits of the preamble signals 311 and 331 of the clock-embedded data signal 301 are respectively “1” “0” “1” and “0” “1” “0”. In this way, a transition manner of the preamble signals 311 and 331 in the clock-embedded data signal 301 is not fixed, and is constantly changed. Therefore, the EMI of the clock-embedded data signal 301 generated due to transition of the preamble signals can be effectively decreased.

Referring to FIG. 3C, FIG. 3C is a waveform diagram of a clock-embedded data signal 302 according to another embodiment of the invention. Different to the aforementioned embodiment, the preamble signal of the clock-embedded data signal 302 includes four bits. Where, the four bits included in a preamble signal 312 of the clock-embedded data signal 302 are sequentially “1” “1” “0” “0”, the four bits included in a preamble signal 332 of the clock-embedded data signal 302 are sequentially “0” “0” “1” “1”, the four bits included in a preamble signal 352 of the clock-embedded data signal 302 are sequentially “0” “0” “1” “0”, and the four bits included in a preamble signal 372 of the clock-embedded data signal 302 are sequentially “0” “1” “0” “1”.

Similarly, a transition manner of the preamble signals 312, 332, 352 and 373 in the clock-embedded data signal 302 is not fixed, and is constantly changed. Therefore, the EMI of the clock-embedded data signal 302 generated due to transition of the preamble signals can be effectively decreased.

It should be noticed that in the embodiments of FIGS. 3A-3C, the number sequence can be a preset fixed sequence, or can be a sequence generated by a random number generator or a scrambler. Moreover, regarding the number sequence, a plurality of random number generation results are generated according to the random number generation method, and then a logic operation is performed on the random number generation results to generate the number sequence. Moreover, the bits of the preamble signal set according to the number sequence are not completely the same.

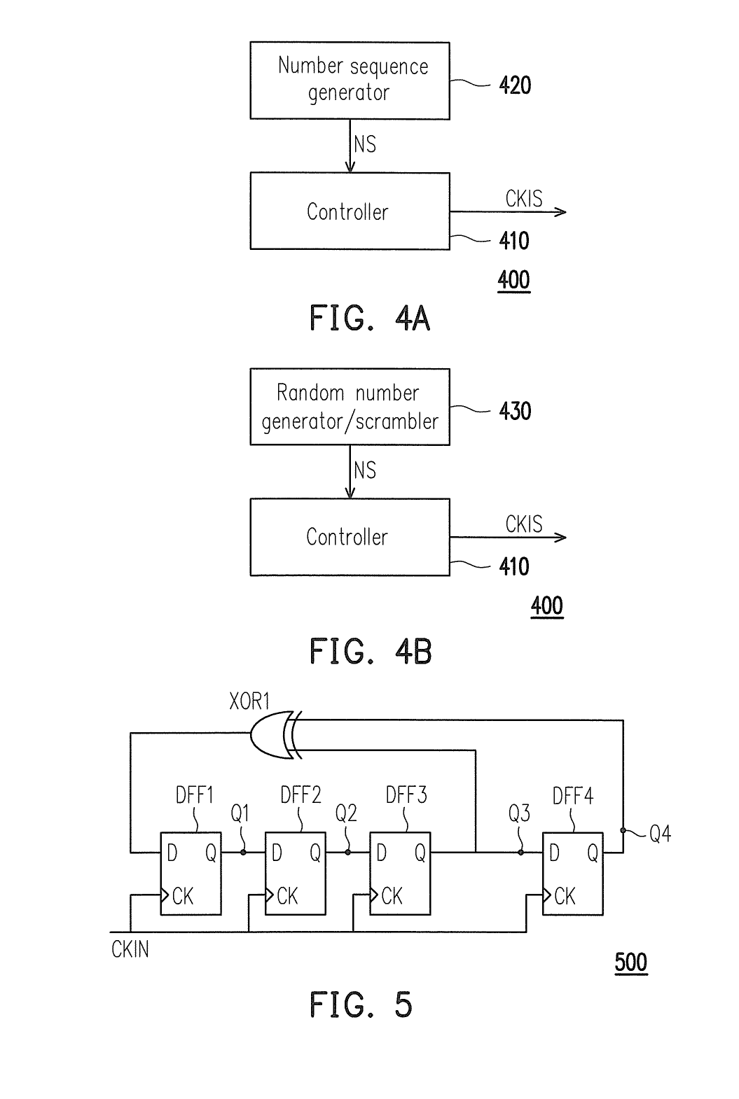

Referring to FIG. 4A, FIG. 4A is a schematic diagram of a clock-embedded data generating apparatus 400 according to an embodiment of the invention. The clock-embedded data generating apparatus 400 includes a controller 410 and a number sequence generator 420. The number sequence generator 420 is configured to generate a number sequence NS and provides the number sequence NS to the controller 410. The controller 410 is configured to generate a clock-embedded data signal CKIS. The controller 410 sequentially generates a plurality of preamble signals according to the number sequence NS. The controller 410 respectively transmits the preamble signals during a plurality of preamble signal transmitting periods, and respectively transmits a plurality of data signals during a plurality of data signal transmitting periods. Each of the data signal transmitting periods occurs after the corresponding preamble signal transmitting period.

Moreover, the number sequence generator 420 can also be built in the controller 410, and when the number sequence NS is a fixed value sequence, the number sequence generator 420 can also be a memory. When the controller 410 generates the preamble signals, the controller 410 is only required to read the number sequence NS from the number sequence generator 420.

Referring to FIG. 4B, FIG. 4B is a schematic diagram of a clock-embedded data generating apparatus 400 according to another embodiment of the invention. The clock-embedded data generating apparatus 400 of the present embodiment includes a random number generator 430 or a scrambler 430 and the controller 410. Different to the embodiment of FIG. 4A, in the present embodiment, the random number generator 430 or the scrambler 430 is used to generate the non-fixed number sequence NS. The random number generator 430 can be implemented by a so-called linear shift feedback register (LSFR).

The scrambler 430 can be a scrambler of any bit number, and implementation details of the scrambler is known by those skilled in the art, so that details thereof are not repeated.

Referring to FIG. 5, FIG. 5 is a schematic diagram of a LSFR 500 according to an embodiment of the invention. The LSFR 500 includes D-type flip-flops DFF1-DFF4 and an XOR gate XOR1. Input terminals of the XOR gate XOR1 is coupled to output terminals Q of the D-type flip-flops DEF4 and DEF4, and an output terminal of the XOR gate XOR1 is coupled to a data input terminal D of the D-type flip-flop DEF1. The D-type flip-flops DFF1-DFF4 are connected in series, and receive a clock signal CKIN through clock input terminals CK. The LSFR 500 generates data Q1-Q4 of a plurality of bits through the output terminals Q of the D-type flip-flops DFF1-DFF4, and the data Q1-Q4 can serve as the number sequence NS.

Here, implementation of the LSFR 500 of FIG. 5 is only an example, which is not used to limit the invention. Those skilled in the art should understand that the LSFR may have multiple implementations, which can all be used as the random number generator of the present embodiment.

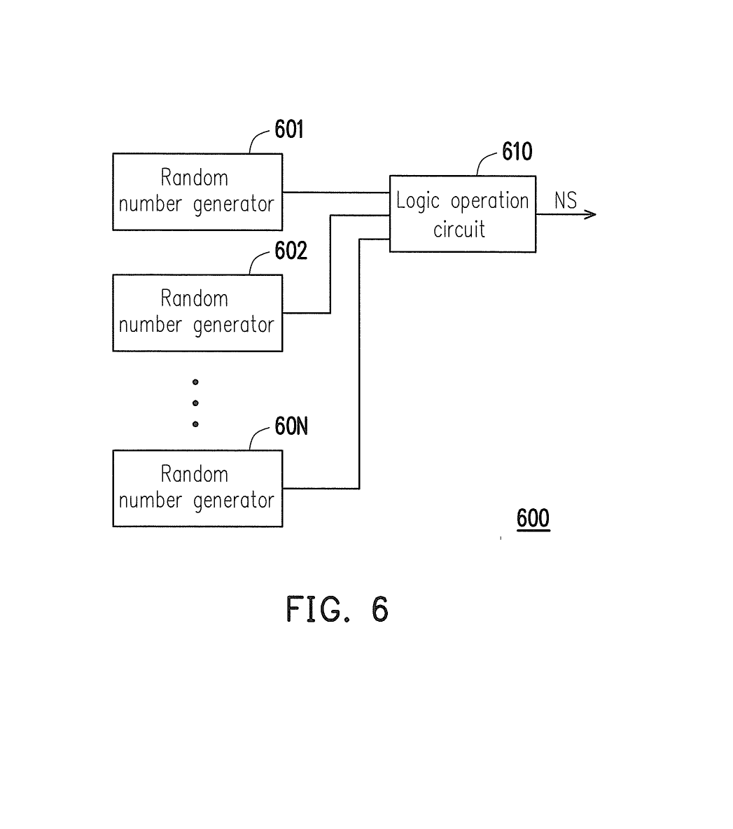

Referring to FIG. 6, FIG. 6 is another implantation of a number sequence generator 600 of clocked-embedded data according to an embodiment of the invention. In the present embodiment, the number sequence generator 600 includes a plurality of random number generators 601-60N and a logic operation circuit 610. The logic operation circuit 610 is coupled to the random number generators 610-60N, and receives a plurality of random number generation results generated by the random number generators 610-60N. The logic operation circuit 610 performs a logic operation on the random number generation results generated by the random number generators 610-60N to generate the number sequence NS.

The logic operation performed by the logic operation circuit 610 may include logic OR, AND, inverse and/or XOR operations, and a designer can determine actual content of the logic operation according to an actual design requirement.

In summary, a plurality of preamble signals with different transition states are generated to effectively decrease the EMI generated during transmission of the clock-embedded data, so as to effectively improve transmission reliability of the clock-embedded data to enhance the whole efficiency of the system.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for transmitting clock-embedded data, comprising:
generating a plurality of preamble signals according to a number sequence, wherein each of the preamble signals comprises a plurality of bits, the number sequence comprises a plurality of values, and the bits of each of the preamble signals are decided by each of the corresponding values; and
respectively transmitting the preamble signals during a plurality of preamble signal transmitting periods, and respectively transmitting a plurality of data signals during a plurality of data signal transmitting periods.

2. The method for transmitting the clock-embedded data as claimed in claim 1, further comprising:
generating the number sequence according to a random number generation method.

3. The method for transmitting the clock-embedded data as claimed in claim 1, further comprising:
generating a plurality of random number generation results according to a random number generation method; and
performing a logic operation on the random number generation results to generate the number sequence.

4. The method for transmitting the clock-embedded data as claimed in claim 1, further comprising:
generating the number sequence through a scrambler.

5. The method for transmitting the clock-embedded data as claimed in claim 1, wherein the bits of the preamble signals are not completely the same.

6. The method for transmitting the clock-embedded data as claimed in claim 1, wherein each of the data signal transmitting periods occurs after each of the preamble signal transmitting periods.

7. A clock-embedded data generating apparatus, comprising:
a number sequence generator, generating a number sequence; and
a controller, coupled to the number sequence generator, and sequentially generating a plurality of preamble signals according to the number sequence, wherein each of the preamble signals comprises a plurality of bit, the number sequence comprises a plurality of values, the bits of each of the preamble signals are decided by each of the corresponding values, and the controller respectively transmits the preamble signals during a plurality of preamble signal transmitting periods, and respectively transmits a plurality of data signals during a plurality of data signal transmitting periods.

8. The clock-embedded data generating apparatus as claimed in claim 7, wherein each of the data signal transmitting periods occurs after each of the preamble signal transmitting periods.

9. The clock-embedded data generating apparatus as claimed in claim 7, wherein the number sequence generator is a random number generator.

10. The clock-embedded data generating apparatus as claimed in claim 9, wherein the random number generator is a linear shift feedback register.

11. The clock-embedded data generating apparatus as claimed in claim 7, wherein the number sequence generator comprises:
a plurality of random number generators, generating a plurality of random number generation results; and
a logic operation circuit, coupled to the random number generators, and performing a logic operation on the random number generation results to generate the number sequence.

12. The clock-embedded data generating apparatus as claimed in claim 7, wherein the number sequence generator is a scrambler.

13. The clock-embedded data generating apparatus as claimed in claim 7, wherein the bits of the preamble signals are not completely the same.
